(19) United States
(12) Patent Application Publication
(10) Pub. No.: US 2012/0131502 A1
(43) Pub. Date: May 24, 2012

(54) On-screen reminder program

(76) Inventors: Taryn Marie Bock, Rowville (AU); Robert Herman Brunner, Melbourne (AU)

(21) Appl. No.: 12/928,750

(22) Filed: Dec. 17, 2010

(30) Foreign Application Priority Data
Nov. 23, 2010 (AU) 2010246373

(51) Int. Cl. G06F 3/048

(52) U.S. Cl. 715/808

(57) ABSTRACT

A computer program for instructing a processor to display to a user of a computing device a reminder for the user to perform an action, the computer program comprising a series of instructions for:
displaying in a window on a screen associated with the computing device the reminder represented by a character that undertakes said action, from a plurality of available actions, to be carried out by the user;
enabling the user to set a predetermined time when one or more of the plurality of actions undertaken by the character is displayed to the user; and
enabling the user to access within the displayed window another of the plurality of actions to display in the window.

### RELATED APPLICATION

This application claims the right of foreign priority under 35 U.S.C. 119 to Application Serial Number 2010246373 filed in Australia on Nov. 23, 2010 by the same inventors, which is incorporated herein by reference in its entirety.

### FIELD OF THE INVENTION

This invention relates to an on-screen reminder program and more particularly it relates to an on-screen reminder program that provides a reminder to a user, typically in a seated position using a computing device such as a PC, to undertake a particular action. More particularly the invention relates to a program to remind a user seated in front of a computing device to perform an action, such as a movement or an exercise.

### BACKGROUND OF THE INVENTION

Users of computing devices at home or in the workplace, such as PCs or laptops, typically spend hours on end sitting in front of or adjacent the screen associated with the computing device without much physical exercise or movement. The user can spend a long time looking at the screen and, apart from using the keyboard and/or mouse, without much physical exertion by the rest of their body. Besides placing a strain on the eyes, wrists, fingers or arms, a person sitting in one spot for a substantial length of time can be unhealthy for that person as such a position can lead to soreness in the hands, arms, forearms, neck and back, particularly where poor posture is used or repetitive actions lead to repetitive strain injuries.

It is up to the individual to remind himself or herself to stop, move around or get up and have a break once in a while. However, such users can get carried away with the work they are undertaking using the computing device and forget to make such movement.

Other arrangements that have been used to remind a user to move or exercise whilst using a computing device, has been to set an external alarm or a timer to go off at various times. However, there is no organised procedure to enable a user to perform particular movements, actions or exercises used on the device. Furthermore, a user may forget what the alarm is for or simply switch it off and ignore performing a movement, action or exercise.

The present invention seeks to provide an improved manner in which a user can have a structured reminder to effectively get the user to perform a particular movement, action or exercise.

### SUMMARY OF THE INVENTION

According to a first aspect of the invention, there is provided a computer program for instructing a processor to display to a user of a computing device a reminder for the user to perform an action, the computer program comprising a series of instructions for:

displaying in a window on a screen associated with the computing device the reminder represented by a character that undertakes said action, from a plurality of available actions, to be carried out by the user;

enabling the user to set a predetermined time when one or more of the plurality of actions undertaken by the character is displayed to the user; and

enabling the user to access within the displayed window another of the plurality of actions to display in the window.

The action preferably includes one or more movements by the character that indicate an action, movement or exercise for a portion of the body of the user to be performed by the user.

The action may be a still image or a set of moving images of the character indicating a reminder message to the user.

The computer program preferably instructs the processor to display a personal reminder in the window for the user. The computer program may enable the user to insert a text message for the reminder and set the date, time and frequency of the reminder. A time interval between display of successive reminders can be set by the user.

The one or more actions may be accompanied by a written instruction in the window on performing the action. A portion of the displayed window can be used to display advertising material. The user can choose a character from a plurality of characters. The window or a separate window may be used to display to the user a regional notice or message, dependent on the geographical location of the user, alerting the user to an event occurring within the local region of the user. The window or a separate window may be used to display to the user an administration message from an administrator.

The user may have access to a previous action displayed, a next action to be displayed or to repeat a displayed action in a sequence of displayed actions within the window. In a sequence of personal reminders, the user can have access to a previously displayed personal reminder, a next personal reminder to be displayed or to repeat a displayed personal reminder within the window.

According to a second aspect of the invention, there is provided a method of providing a reminder to a user of a computing device in order for the user to perform an action, the method including the steps of:

displaying in a window on a screen associated with the computing device the reminder represented by a character that undertakes said action, from a plurality of available actions, to be carried out by the user, the character being generated by a first executable portion of a computer program;

enabling the user, through a second executable portion of the computer program, to set a predetermined time when one or more of the plurality of actions undertaken by the character is displayed to the user; and

enabling the user, through a third executable portion of the computer program, to access within the displayed window another of the plurality of actions to display in the window.

In the method, the action may includes one or more movements by the character that indicate an action, movement or exercise for a portion of the body of the user to be performed by the user.

In the method, the action may be a still image or a set of moving images of the character indicating a reminder message to the user.

The method may further include displaying a personal reminder in the window for the user.

The method may further include displaying a regional notice or message to the user in the window or a separate window, the regional notice or message being dependent on the geographical location of the user, alerting the user to an event occurring within the local region of the user.

The method may further include displaying an administration message from an administrator to the user in the window or a separate window.

According to a third aspect of the invention, there is provided a system for providing information to a user of a computing device, the system comprising:

a first server for downloading a computer program that displays to the user on the computing device a reminder for the user to perform an action;

a communications network connecting said first server to the computing device;

wherein the reminder is displayed in a window on a screen of the computing device and is represented by a character that undertakes said action, from a plurality of available actions, to be carried out by the user, the character being generated by a first executable portion of the computer program;

wherein further the user, through a second executable portion of the computer program, is able to set a predetermined time when one or more of the plurality of actions undertaken by the character is displayed to the user; and

wherein further the user, through a third executable portion of the computer program, is provided with the option of accessing within the displayed window another of the plurality of actions to display in the window.

The system may further include a second server connected to the communications network and to the computing device.

A regional notice or message may be sent to the user computing device and/or any other user computing device from the first server and displayed in the respective window or a separate window, the regional message being dependent on the geographical location of the user and/or other users, alerting the user or users to an event occurring within the local region of the user or users.

An administration message can be sent by an administrator via the first server to the user computing device and/or user computing devices, that can be linked to the second server, and displayed in the respective window or a separate window on the computing devices.

According to a fourth aspect of the invention, there is provided a computer program product including at least one computer-readable storage medium having computer-readable program code portions stored therein, the computer-readable program portions having:

a first executable portion for displaying in a window on a screen associated with a computing device a reminder represented by a character that undertakes an action, from a plurality of available actions, to be carried out by a user;

a second executable portion for setting a predetermined time when one or more of the plurality of actions undertaken by the character is displayed to the user; and

a third executable portion for enabling the user to access within the displayed window another of the plurality of actions to display in the window.

According to a fifth aspect of the invention, there is provided a computer usable medium having a computer readable program code embodied therein, said computer readable program code adapted to be executed to implement a method for:

displaying in a window on a screen associated with the computing device the reminder represented by a character that undertakes said action, from a plurality of available actions, to be carried out by the user;

enabling the user to set a predetermined time when one or more of the plurality of actions undertaken by the character is displayed to the user; and

enabling the user to access within the displayed window another of the plurality of actions to display in the window.

According to a sixth aspect of the invention, there is provided a computer-readable media containing a computer program for displaying to a user of a computing device a reminder for the user to perform an action, the computer program comprising a series of instructions for:

displaying in a window on a screen associated with the computing device the reminder represented by a character that undertakes said action, from a plurality of available actions, to be carried out by the user;

enabling the user to set a predetermined time when one or more of the plurality of actions undertaken by the character is displayed to the user; and

enabling the user to access within the displayed window another of the plurality of actions to display in the window.

According to a seventh aspect of the invention, there is provided a system for displaying to a user a reminder for the user to perform an action, the system comprising:

a user computing device having a storage device, a processor, an input device and an output device, the processor being programmed to:

display in a window on the output device of the computing device the reminder represented by a character that undertakes said action, from a plurality of available actions, to be carried out by the user;

enable the user to set a predetermined time when one or more of the plurality of actions undertaken by the character is displayed to the user, the user setting the predetermined time using the input device to; and

enable the user to access within the displayed window another of the plurality of actions to display in the window by using the input device.

### BRIEF DESCRIPTION OF THE DRAWINGS

A preferred embodiment of the invention will hereinafter be described, by way of example only with reference to the accompanying drawings in which:

FIG. 1 is a block diagram of a system used to download and provide updates to an on-screen reminder program;

FIG. 1A is a block diagram of basic components of a user computing device that forms part of the system of FIG. 1;

FIG. 2 is a view of a screen on a computing device of a user showing a pop-up window providing access to the program;

FIG. 3 shows a more detailed view of the pop-up of FIG. 2 with a character performing an action with a message for the user to undertake;

FIG. 4 is a screen showing a personal reminder for the user;

FIG. 5 is a view of a screen showing a window that provides various options available within the program;

FIG. 6 shows a personal reminder window enabling a user to form or alter a reminder;

FIG. 7 is a screen showing an “options window” that enables various options to be entered associated with the program;

FIG. 8 is a flow diagram showing the steps taken by the program and options made available to the user; and

FIG. 9 is a flow diagram showing processes undertaken by a remote server and by the program in terms of providing signals or updates to the program.

### DETAILED DESCRIPTION OF THE PREFERRED EMBODIMENT

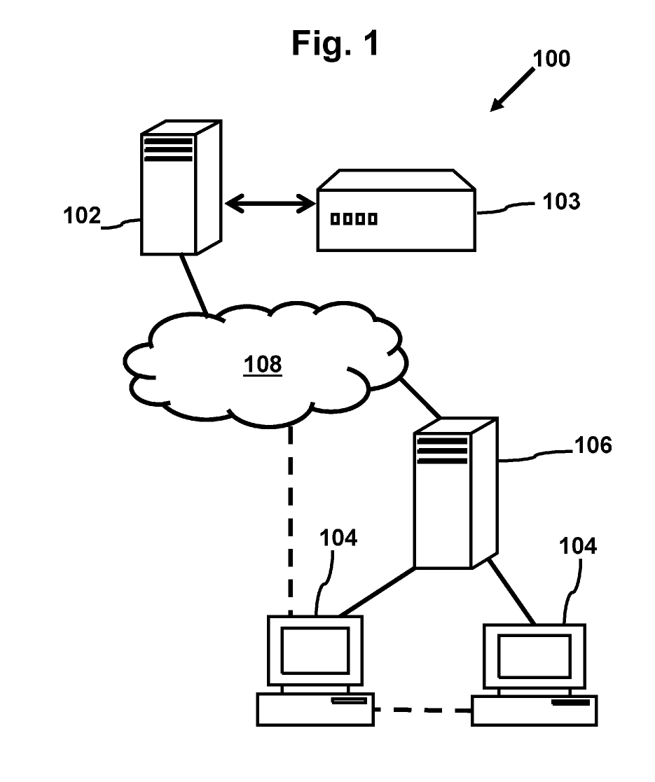

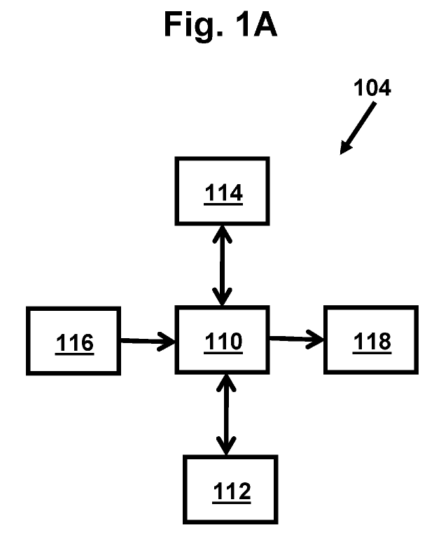

Referring to FIG. 1, there is shown a block diagram of a system 100 used to download a computer program from a first server, being a remote server 102, to either a computing device, such as stand alone PC 104 or to a second server, such as company server 106, over a communications network, such as the interne 108. Whether the program is downloaded to company server 106, depending on the number of licences obtained, these can be distributed to a number of PC's 104 that are directly connected to the company server 106.

When the program has been downloaded to either company server 106 or PC 104, a user of PC 104 logs on to the computing device and the computer program is initiated as part of the “start up” function of the logging-in process.

In FIG. 1A there is shown the basic components of the user computing device 104. The device 104 includes a processor 110, main memory 112 such as a hard disk, RAM 114, input devices such as a mouse, keyboard, touch pad or touch screen 116 and output device 118 such as a screen/monitor.

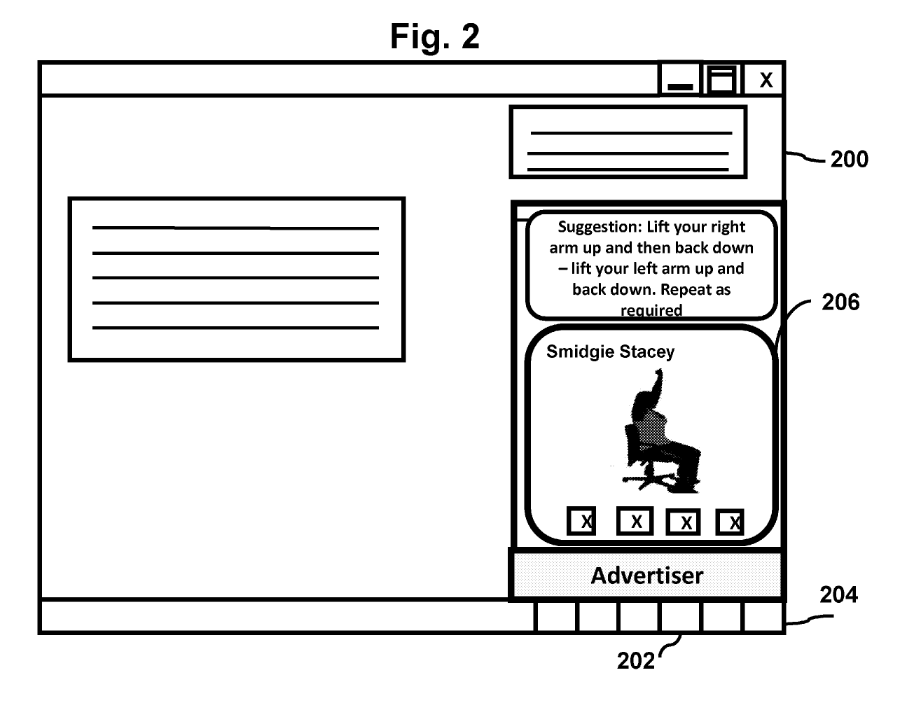

In FIGS. 2-5, corresponding numerals generally apply between the figures.

Referring to FIG. 2, an icon 202 of the program will appear in the system tray 204 that forms part of the screen 200 displayed to the user on PC 104. The program, stored in a memory 112, 114 of PC 104, provides instructions, through a first executable portion, to a processor 110 on PC 104 to display the icon 202 on screen 200. On double clicking the icon 202 by the user, that is by left double clicking on the icon 202, it causes the program to run whereby window 206 appears in the bottom right hand corner of the screen 200. The window 206 generally covers approximately 10% or greater area of the screen 200. The actual area of the screen 200 covered by window 206 is adjustable.

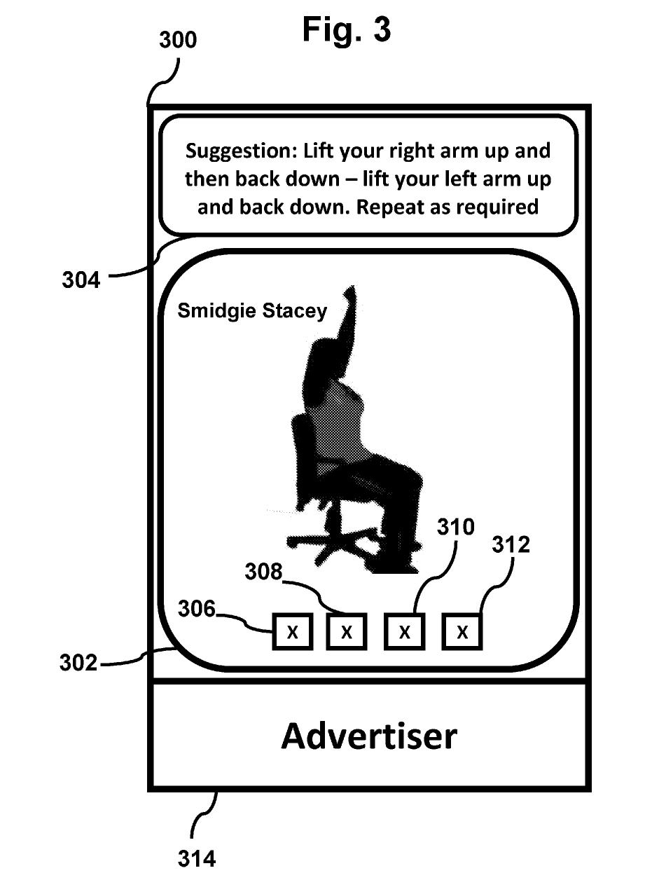

A more detailed view of window 206 is shown in FIG. 3 and is depicted as action/information screen 300. The image that appears in the portion 302 can be either an action or movement by a character, a personal reminder to the user, an administrator message or a regional message. The character is generally distinctive and has personality.

In the movement mode, an action to be undertaken by the user is displayed in portion 302 at the next scheduled time. The action is an animation by a chosen character showing a simple movement that can last for up to 60 seconds before automatically closing when there has been no input to the control buttons 306 to 312 from the user. The animation or video image is one of many that is stored in the memory 112, 114 on PC 104 and is randomly, under instruction from the program, retrieved and displayed on screen 200. Individual images/movements can be selected by the user to be displayed at times or intervals, also selected by the user, through a second executable portion of the computer program. The user may alternate between displayed images by using the previous button 306 to display the previous image, next button 310 to display the next image, a repeat button 308 in order to repeat the image just displayed and finish button 312 in order to close the current item. On clicking any of the buttons 306 to 312 by the user using a keyboard or mouse, these interactions are recorded by the program upon which the program, through a third executable portion, instructs the processor in PC 104 to perform the necessary action. In window 304 a text message may be displayed that provides suggestions for the user to read to assist the user to undertake the displayed movement, action or exercise. Additionally in box 314 there is provided a space reserved for advertising material.

Examples of images that may display a simple movement, action or exercise can be to remind the user to stretch or move his/her back or neck, stretch or move the arms, hands or feet, focus the eyes away from the screen 200, perform eye exercises or simple finger movements. In addition, “seated only” movements, actions or exercises can be provided for users that are wheelchair bound or are unable to stand. As many different movements, actions or exercises as are necessary or requested can be stored in the original program in the memory of the PC 104 or be sent as an update from remote server 102, to be described hereinafter. Initially two different animated sequences are available. The first sequence is a seated sequence for users who are in wheelchairs or otherwise cannot move around or stand. The second sequence will be a mixture of standing, seated or moving around exercises, for example conducting a movement, action or exercise behind a chair or against a nearby wall. Although there are many different types of animated sequences that can be displayed, the user will have a choice to repeat or display up to five such sequences using the buttons 306 to 310.

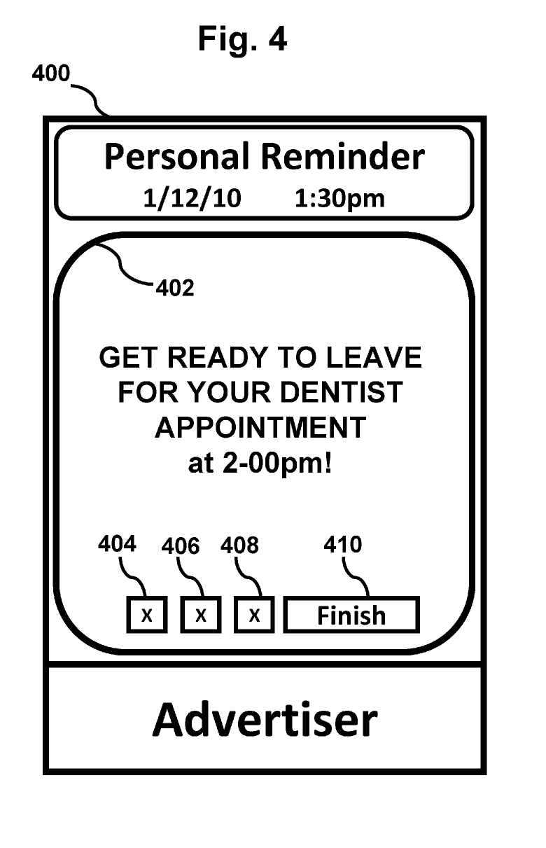

A second mode that is initiated by the program is a personal reminder mode, a window 400 which is shown in FIG. 4. The reminders are set by the user at a particular time to be automatically shown by the program on the screen 200 to the user, in the same window that the movement modes are shown. The reminder is shown in text, an example of which is shown at 402 on screen 200. If more than one message exists, then each message is displayed for a short time and will move in sequence and be repeated until all messages have been displayed. Or alternatively the previous button 404, next button 406 or repeat button 408 can be used to skip through each of the messages. Individual messages will need to be deleted by clicking on the finish button 410 before the window 400 minimises.

Alternatively, the personal reminder message may be a depiction of the character that is used in the movement mode but is a still image with the character, for example, holding a board with the message/reminder written on the board and to be read by the user. The character may be in any one of a number of poses and the message may be delivered in a text format on any particular medium that is associated or used by the character.

A third message mode is the administrator message mode. It will be provided in a window, such as window 400 or window 206, and the message can be initiated by the administrator, for example, in a company which is sent from company server 106. The message will be transmitted to the first (remote) server 102 to verify the authentication of the administrator and confirm with the administrator that the message is to be sent to one or more of the licensed users using a PC 104 that is connected to or uses the company server 106. This is usually done by an exchange of emails or other messages between servers 102 and 106. Once confirmation and authentication is achieved, the first server 102 sends the message to each of the relevant users on the various PCs 104 (associated with the second server 106). Again if more than one message exists, then each will be displayed for a short time and moved in sequence and repeated until all messages have been displayed. The buttons 404 to 408 may be used to skip through each of the messages. Each individual message will need to be deleted by clicking on the finish button 410 before the window showing the message minimises.

A further message mode that is undertaken by the program is a regional message mode, which is geographically based, where for example the same message can be sent over the internet 108 from servers such as 102 to a number of recipients. The regional message will be presented in a window similar to window 400 or 206 and is defined by the regional location of the particular PC in conjunction with local authorities of that geographical region, for example a flood or bushfire warning. The message will only disappear when it is acknowledged via depressing the finish button 410. This particular mode is reserved for a significant message that affects the whole of the local region, for example a flood or bushfire. The remote server 102 is used in conjunction with other communication means associated with the local authorities. If more than one message exists then each message is displayed for a short time and moved in sequence and repeated until all of the messages have been displayed. The messages can be skipped through by using the buttons 404, 406 and 408.

The regional message may be displayed in a separate box to the box 400 or 206 and draw the attention of the user, for example in a flashing mode and where it is prominently displayed on the screen such as in the centre of the screen. It is possible that one of the other three modes simultaneously shows a reminder or message when a regional message is being broadcast to the user.

In all of the above four modes, that is movement mode, personal reminder mode, administrator message mode and regional message mode each message may be accompanied by audio, stored in memory and accessed by the program, to alert the user who may not be looking at the screen at that particular time. Where the movement or personal reminder mode is used showing the character, the accompanying audio can be shown as if emanating from the character, for example, conversation, instruction, orders or singing to mention a few forms of audio.

In arranging display of all of the messages, this is based on a set time for the movement mode and the personal reminder mode or can be initiated at any time in the case of an administrator message or a regional message to be broadcast and displayed. In each of the first two cases, movement mode and personal reminder mode, the program instructs the processor associated with PC 104 to display the message after comparison between an internal timer with the time set for the message.

The section 314 is reserved for advertising material, wherein the display of various advertisements will be controlled by the program according to an advertising schedule. Each advertisement may have a sound or animation associated with it and be extracted from memory of any one of PC 104, company server 106, or remote server 102.

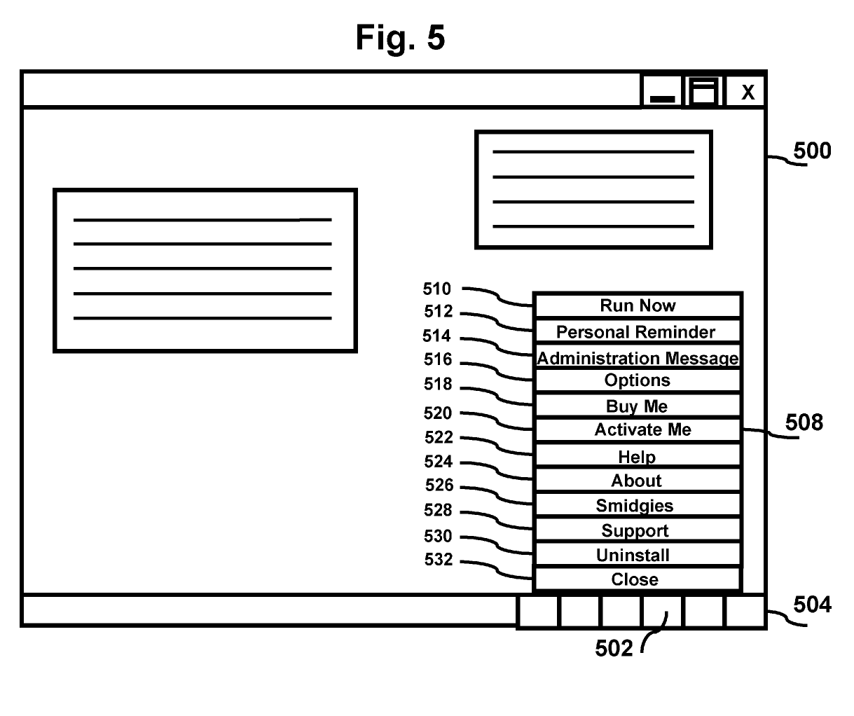

As mentioned previously by left double clicking on the icon 202, this will cause the program to run. By right clicking on the icon 202 it will initiate a menu as shown in FIG. 5 with the icon now referred to as 502. The menu 508 appears on screen 500 in the window 506. Clicking away from the menu 508 will cause the menu 508 to close.

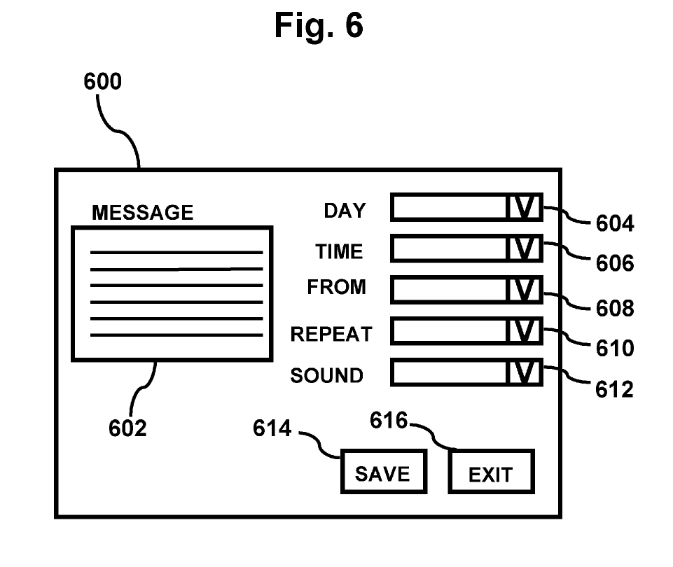

The menu 508 consists of a number of files and applications that can be opened, some of which can be modified by the user to control the display and timing of the messages in window 506. The “run now” application 510 can be selected in order to start the program. Alternatively, a personal reminder window can be opened by clicking option 512 which enables the user to set a new personal reminder. An example of such a window is shown in FIG. 6 in window 600. In box 602 a particular reminder message can be entered and have up to a maximum of 100 characters. In box 604 the day that the reminder is to be sent is entered and in box 606 the time is entered for that day. Box 608 provides an option to set the reminder at a period of time from the present, for example, in one hour or two hours from the present time. Box 610 enables the reminder to be repeated after a set time period, for example, at the same time each day. In box 612 a sound can be applied to accompany the message. Once the message is complete the user clicks on the save button 614 and exits at 616. The reminder is then stored in memory of PC 104 and accessed by the program at the set time. When the reminder appears at the set time and is acknowledged by depressing the finish button, the reminder is then automatically deleted.

Referring back to FIG. 5, option 514 on the menu 508 is for the administration message window to be opened. This is only available on licensed PCs and the feature can only be actioned by the nominated administrator. The particular administration message will, for example, appear on all licensed PC, under the multi-user licence purchased by the particular company that owns the company server 106.

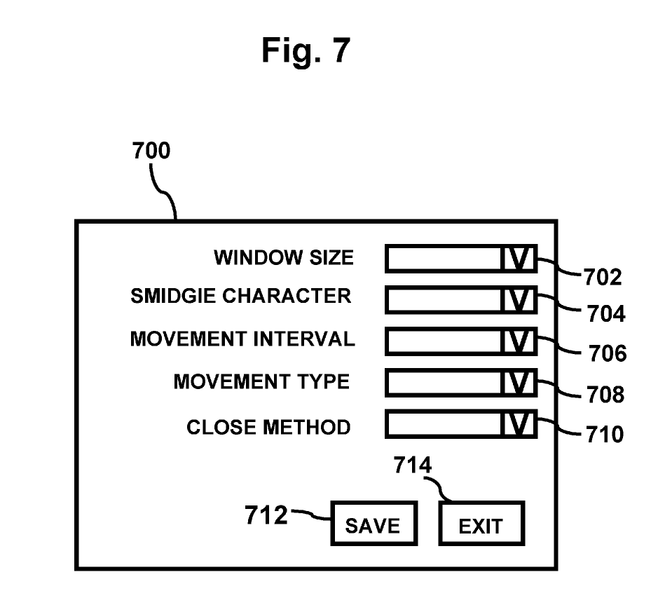

By clicking on option 516 this opens an options window. An example of the options window is shown at FIG. 7, as window 700. A drop down box 702 allows the user to have the size of the window 206 run in a large or small format with the default being small. Drop down box 704 enables one of a number of animation characters to be selected or be displayed in the various action messages, such as movements or exercises which may be undertaken by the user. Each of the characters can be animated and perform a sequence of movements or be still or provide an indication to the user as to what action to undertake. A default character may be used.

In drop down menu box 706 the preferred time interval between movements being shown can be selected with the default being 45 minutes. Thus at every interval the selected character will perform a chosen movement, action or exercise or a still graphic from a range of movements, actions or exercises stored in memory for the user to view.

In drop down box 708 the type of movement may be selected. The default is for all movements to be shown by the selected character. As mentioned previously, “seated only” movements, actions or exercises can be selected.

In drop down box 710, the close method is selected with a default being to automatically close within 15 seconds. That is the exercise or action being performed by the selected character is to close automatically within 15 seconds. For the longer actions performed by the character, a longer close time is selected.

All of the changes are saved by depressing button 712 and the “options window” 700 or exited by icon button 714. The various changes are then stored in the memory of PC 104 and accessed by the program.

Returning to FIG. 5 in the menu 508, a further option 518 can be selected which provides a link to purchase the software product where a free trial is currently being used by the user.

The option 520 opens up an “activate me” window in which the current licence status is displayed, that is, either a free licence or a paid licence which includes for each the date of expiry or days remaining. There is also disclosed the company name if licensed or a “home use only” if unlicensed. If the program is licensed then the license number is displayed or if it is only for home use, a series of zeros is shown as the licence. A load button is displayed to load a License File. This will allow the user to browse to the location of the License File and then open it. If the License File is valid, it will cause the computer program to operate in License mode. Two types of License Files are provided to the user:

(1) A “Standard” License File suitable for all standard user functions;

(2) An “Administrator” License File for users appointed to manage the “administration messages” in addition to the standard user functions.

The user must load whichever License File is appropriate for their position regarding the programs “Administrator Message” management.

By clicking on button 522, this opens up a “help” window that has a list of frequently asked questions and a link to a help page of the owner operator of the program.

Option 524 displays information about the current version of the character being used to display the various actions as well as status information on that character. It also displays disclaimer, warranty, owner and licensee details. It also displays the current license and a link to the owner/operator web site.

Option 526 provides an explanation of what the character is and displays a link back to the owner/operator website. Option 528 opens a support window which displays support contact details and a manual as well as details of remote functions and an option to “autofix”. Autofix checks all local files and attempts to download any damaged or missing files from first server 102.

Option 530 accesses an “uninstall” window which displays various uninstall options and requests confirmation if uninstall is selected. Option 532 is the “close” window that when clicked confirms that the user actually wants to close down the program.

Referring to FIG. 1 again, the system 100 uses a database 103 which is not directly accessible by the internet but only through server 102. The remote server 102 is preferably based on a standard PHP/MySQL server system. The database 103 is a MySQL database and all communications to database 103 is via PHP logic at the remote server 102. Communications to and from the remote server 102 over the internet 108 will be encrypted through any available encryption format.

Database 103 stores all information required to control the various aspects of behaviour of the characters that are shown in animated form as reminders to each registered user. Such behaviour includes animation, advertising, schedules, client data, licenses, version control, and messages from administrators and messages associated with regional or geographically based occurrences.

The remote server 102 is used in combination with database 103 to transmit any update information that is required for all the programs that are being downloaded and stored on the various PCs 104 or company server 106. PHP logic controls all of the transmissions between the recipient clients, being PC 104 or company server 106, and the remote server 102. Each information message or transaction is encrypted before transmission and then decrypted on receipt This occurs in both directions across the internet 108. All transactions or messages between the clients and the server are via predefined commands from a command library stored in database 103. Any update information required to be downloaded on the client computing devices can be sent at any time or at predefined times.

The program that is stored on each of the client devices such as PC's 104 or company server 106, periodically poll the remote server for any messages that are required to be transmitted and shown to the end users, such as administrator messages or regional based messages or updates that are required for any of the functions within the program. As an example, the program might request more movements, actions or exercises to be transmitted over the internet to the relevant PC which would be a separate action aside from polling the remote server 102. The remote server, in communication with database 103 may then forward another set of actions that can last for the next week or the next few days.

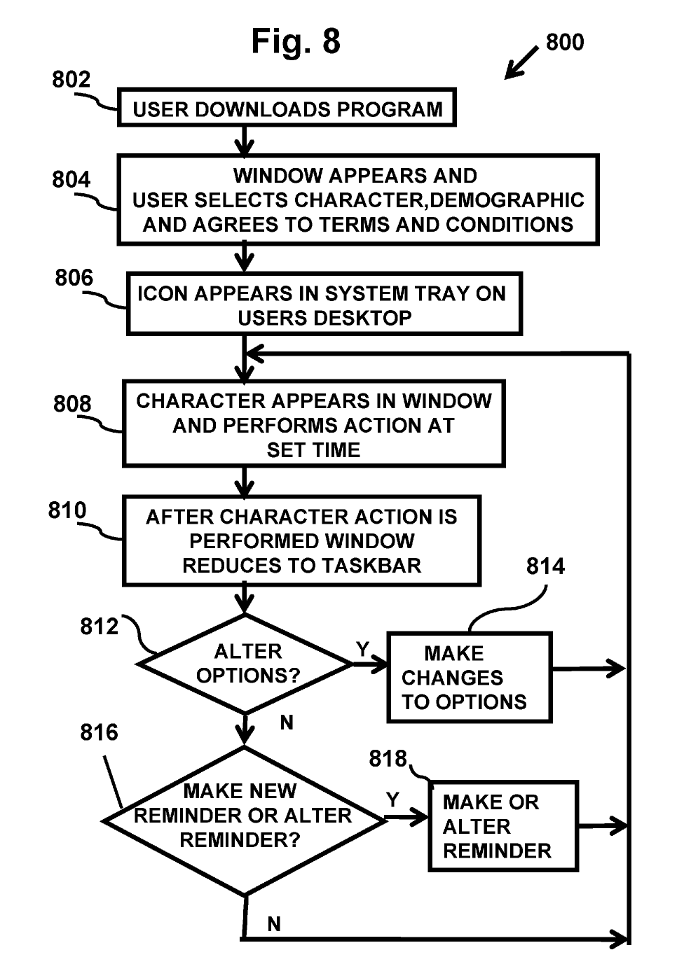

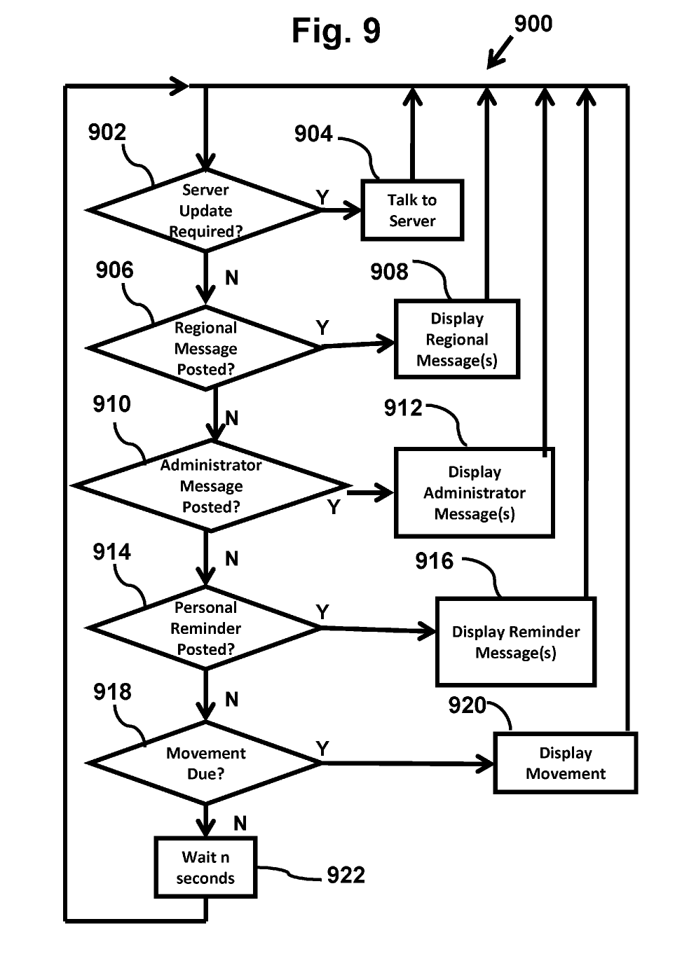

The computer program instructions may be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or steps(s), such as in FIGS. 8 and 9.

Referring to FIG. 8 there is shown a flow diagram 800 of steps used by the program and options available to the user of the program. At step 802 the user downloads the program from the first server (remote) server 102. At step 804 after downloading and installing the program, a window appears on the screen of the computing device of the user to ask the user to select preferences on the character that they wish to use, enter basic end user demographic information and agree to the terms and conditions of the license. Various characters can be selected and can appear at a range of intervals, such as in 30 minutes, 45 minutes, an hour, 90 minutes or two hours. These options, that is number of characters and time intervals to select from, are reduced for users trialling the program.

At step 806 after the completion of the step 804, the window reduces and a character as chosen by the user appears as a small icon in the system tray 204 on the screen of the user's computing device. At step 808, at the set time the character appears in a window approximately 7cm square on the right hand side of the screen and performs the action, chosen from a plurality of actions or messages stored in the memory of the user's computing device (see 300). This can be accompanied by explanatory text about the action and an advertisement. A disclaimer may also be displayed stating that the owner/operator does not accept liability if a user is injured as a result of performing an action, movement or exercise.

At step 810 after the action or message has been performed, the window that displayed the action or message is then reduced in size and is removed to the system tray again. At step 812 if the user wishes to alter any of the options available in the program this is done at step 814 which can include making changes to the type of character used, the time interval between the display of messages and what sort of action/movement is to be displayed. The process then returns to step 808.

Where no option needs to be altered at step 812, the process moves to the decision box 816 where an option is given to the user to make or alter a reminder. Where a new reminder has to be made or changes to an existing reminder is required, this is done at step 818 and the process returns to step 808. Otherwise if no changes are to be made to the reminder or no new reminders are needed then the process moves again to step 808.

With reference to FIG. 9 there is shown a flow diagram of communications between the remote server 102 and client devices such as PC 104 or company server 106. It also discloses action steps to be undertaken by the program that resides on the client device itself. The flow diagram 900 starts at decision box 902 where a determination is made as to whether a server update is required to be downloaded to the user's computing device. If “yes” then a communication is made at step 904 with the server 102 and the required updates are downloaded. If not, then the process moves to decision box 906 where the server 102 is polled as to whether a regional message has been posted. If the answer is “yes” then at step 908 the regional message is displayed by transmitting the message from the remote server 102 to the various users’ PCs 104. Where no regional message is to be posted then the process moves to box 910 where a determination is made as to whether an administrator message has been posted, for example by company server 106. If this is the case then the administrator message is displayed at step 912. If no administrator message is to be posted the process moves to decision box 914 where a determination on whether a personal reminder has been posted is made. Where a personal reminder is current then at the set time the reminder message is displayed at step 916.

If no personal reminder has been posted or is current, the process moves to decision box 918 where a determination as to whether a movement or action sequence needs to be commenced. If “yes” then the movement, action or reminder to be undertaken by the character is displayed at step 920. Otherwise the process moves to 922 and undertakes no action until the required time when a reminder or action to be performed by the character is due.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A computer program for instructing a processor to display to a user of a computing device a reminder for the user to perform an action, the computer program comprising a series of instructions for:
displaying in a window on a screen associated with the computing device the reminder represented by a character that undertakes said action, from a plurality of available actions, to be carried out by the user;
enabling the user to set a predetermined time when one or more of the plurality of actions undertaken by the character is displayed to the user; and
enabling the user to access within the displayed window another of the plurality of actions to display in the window.

2. Computer program according to claim 1 wherein the action includes one or more movements by the character that indicate an action, movement or exercise for a portion of the body of the user to be performed by the user.

3. Computer program according to claim 1 wherein the action is a still image or a set of moving images of the character indicating a reminder message to the user.

4. Computer program according to claim 1 wherein the computer program instructs the processor to display a personal reminder in the window for the user.

5. Computer program according to claim 4 wherein the computer program enables the user to insert a text message for the reminder and set the date, time and frequency of the reminder.

6. Computer program according to claim 1, wherein a time interval between display of successive reminders is set by the user.

7. Computer program according to claim 1 wherein the one or more actions is accompanied by a written instruction in the window on performing the action.

8. Computer program according to claim 1 wherein a portion of the displayed window is used to display advertising material.

9. Computer program according to claim 1 wherein the user chooses a character from a plurality of characters.

10. Computer program according to claim 1 wherein the window or a separate window is used to display to the user a regional notice or message, dependent on the geographical location of the user, alerting the user to an event occurring within the local region of the user.

11. Computer program according to claim 1 wherein the window or a separate window is used to display to the user an administration message from an administrator.

12. Computer program according to claim 1 wherein the user has access to a previous action displayed, a next action to be displayed or to repeat a displayed action in a sequence of displayed actions within the window.

13. Computer program according to claim 4 wherein in a sequence of personal reminders the user has access to a previously displayed personal reminder, a next personal reminder to be displayed or to repeat a displayed personal reminder within the window.

14. A method of providing a reminder to a user of a computing device in order for the user to perform an action, the method including the steps of:
displaying in a window on a screen associated with the computing device the reminder represented by a character that undertakes said action, from a plurality of available actions, to be carried out by the user, the character being generated by a first executable portion of a computer program;
enabling the user, through a second executable portion of the computer program, to set a predetermined time when one or more of the plurality of actions undertaken by the character is displayed to the user; and
enabling the user, through a third executable portion of the computer program, to access within the displayed window another of the plurality of actions to display in the window.

15. A method according to claim 14 wherein the action comprises one or more movements by the character that indicate an action, movement or exercise for a portion of the body of the user to be performed by the user.

16. A method according to claim 14 wherein the action is a still image or a set of moving images of the character indicating a reminder message to the user.

17. A method according to claim 14 further comprising displaying a personal reminder in the window for the user.

18. A method according to claims14 further comprising displaying a regional notice or message to the user in the window or a separate window, the regional notice or message being dependent on the geographical location of the user, alerting the user to an event occurring within the local region of the user.

19. A method according to claim 14 further comprising displaying an administration message from an administrator to the user in the window or a separate window.

20. A system for providing information to a user of a computing device, the system comprising:
a first server for downloading a computer program that displays to the user on the computing device a reminder for the user to perform an action;
a communications network connecting said first server to the computing device;
wherein the reminder is displayed in a window on a screen of the computing device and is represented by a character that undertakes said action, from a plurality of available actions, to be carried out by the user, the character being generated by a first executable portion of the computer program;
wherein further the user, through a second executable portion of the computer program, is able to set a predetermined time when one or more of the plurality of actions undertaken by the character is displayed to the user; and
wherein further the user, through a third executable portion of the computer program, is provided with the option of accessing within the displayed window another of the plurality of actions to display in the window.

21. A system according to claim 20 further comprising a second server connected to the communications network and to the computing device.

22. A system according to claim 20 wherein a regional notice or message is sent to the user computing device and/or any other user computing device from the first server and displayed in the respective window or a separate window, the regional notice or message being dependent on the geographical location of the user and/or other users, alerting the user or users to an event. occurring within the local region of the user or users.

23. A system according to claim 21 wherein an administration message is sent by an administrator from the first server to the user computing device and/or user computing devices linked to the second server and displayed in the respective window or a separate window on the computing devices.

24. A computer program product including at least one computer-readable storage medium having computer-readable program code portions stored therein, the computer-readable program portions having:
a first executable portion for displaying in a window on a screen associated with a computing device a reminder represented by a character that undertakes an action, from a plurality of available actions, to be carried out by a user;
a second executable portion for setting a predetermined time when one or more of the plurality of actions undertaken by the character is displayed to the user; and
a third executable portion for enabling the user to access within the displayed window another of the plurality of actions to display in the window.

25. A computer useable medium having a computer readable program code embodied therein, said computer readable program code adapted to be executed to implement a method for:
displaying in a window on a screen associated with the computing device the reminder represented by a character that undertakes said action, from a plurality of available actions, to be carried out by the user;
enabling the user to set a predetermined time when one or more of the plurality of actions undertaken by the character is displayed to the user; and
enabling the user to access within the displayed window another of the plurality of actions to display in the window.

26. A computer-readable media containing a computer program for displaying to a user of a computing device a reminder for the user to perform an action, the computer program comprising a series of instructions for:
displaying in a window on a screen associated with the computing device the reminder represented by a character that undertakes said action, from a plurality of available actions, to be carried out by the user;
enabling the user to set a predetermined time when one or more of the plurality of actions undertaken by the character is displayed to the user; and
enabling the user to access within the displayed window another of the plurality of actions to display in the window.

27. A system for displaying to a user a reminder for the user to perform an action, the system comprising:
a user computing device having a storage device, a processor, an input device and an output device, the processor being programmed to:
display in a window on the output device of the computing device the reminder represented by a character that undertakes said action, from a plurality of available actions, to be carried out by the user;
enable the user to set a predetennined time when one or more of the plurality of actions undertaken by the character is displayed to the user, the user setting the predetermined time using the input device to; and
enable the user to access within the displayed window another of the plurality of actions to display in the window by using the input device.
